(19) United States
(12) Patent Application Publication
(10) Pub. No.: US 2005/0268661 A1
(43) Pub. Date: Dec. 8, 2005

(54) Method and apparatus for manufacturing curved glass plate

(76) Inventors: Hideo Yoshizawa, Sagamihara-shi (JP); Kazuhisa Ono, Sagamihara-shi (JP); Mitsuo Tanaka, Saitama-ken (JP)

Correspondence Address: FULBRIGHT & JAWORSKI, LLP, 666 FIFTH AVE, NEW YORK, NY, 10103-3198, US

(21) Appl. No.: 11/143,789

(22) Filed: Jun. 1, 2005

(30) Foreign Application Priority Data
Jun. 1, 2004 (JP) 2004-163158

(51) Int. Cl. C03B 23/02

(52) U.S. Cl. 65/103; 65/106; 65/288; 65/273

(57) ABSTRACT

A method for manufactuing a curved glass plate includes the steps of mounting a single glass plate blank heated to a deformable temperature in a heating furnace on a lower mold configured for supporting a lower face peripheral edge of the glass plate blank outside the heating furnace, pressing a curvature forming upper mold which bulges downwardly against an upper face of the glass plate to form a curvature in the glass plate and coolign the curved glass plate as being mounted on the lower mold by natural cooling or near-natural cooling, thereby to obtain the curved glass plate as a final product. During the step of cooling the glass plate on the lower mold, the lower mold is heated whereas an inner portion of the lower face of the glass plate adjacent the portion of the glass plate placed in contact with the lower mold is forcibly cooled.

### BACKGROUND OF THE INVENTION

1. Field of the Invention

The present invention relates to a method for manufacturing a curved glass plate comprising the steps of mounting a sire glass plate heated to a deformable temperature in a heating furnace on a lower mold configured for supporting a lower face peripheral edge of the glass plate outside the heating furnace, pressing a curved upper mold which bulges downwardly against an upper face of the glass plate to form a curvature in the glass plate and cooling the curved glass plate as being mounted on the lower mold by natural cooling or near-natural cooling, thereby to obtain the curved glass plate as a final product. The method relates also to an apparatus for manufacturing a curved glass plate comprising a lower mold configured for supporting, outside a heating furnace, a lower face peripheral edge of a single glass plate which has been heated to a deformable temperature in the heating furnace and a curved upper mold which bulges downwardly and is disposed upward of the lower mold, the lower mold and the upper mold being vertically movable closer to and away from each other;

2. Background Art

Such curved glass plate is for use as e.g. an outer glass plate of a laminated glass employed in a windshield, a back window or a side window of an automobile. For manuring such curved glass plate, there are known a method and an apparatus constructed such that a glass plate which has been heated to a deformable temperature in a heating furnace is mounted, outside the furnace, on a lower mold configured for supporting a lower face peripheral edge of the glass plate and then bent by an upper mold, then, cooling air is blown against the entire upper and lower faces of the glass plate for forcible rapid cooling thereof (see e.g. Patent Document 1: Japanese Patent Application “Kokai” No. 5-170468).

In the above respect, when the heated glass plate is annealed uniformly in its plate thickness direction and its plate surface direction, no residual stress occurs in the glass plate at the room temperature.

However, if the uniformly heated glass plate is quenched or naturally cooled, due to the small thermal conductivity of the glass, in the plate thickness direction, the temperature of the upper and lower surface layers will be lower than the temperature of the center layer. As a result, when the glass plate has reached the room temperature, there will have occurred a residual compressive stress in the surface layers whereas a residual tensile stress in the center layer. This phenomenon is referred to as “residual cross sectional stress”.

On the other hand, regarding the surface direction, in the area adjacent the periphery of the glass plate, the upper and lower surfaces and the edge (i.e. the face extending in the thickness direction) of the glass plate at this area will be cooled to a lower temperature than the other “inner” portion of the glass sheet, so that a residual plane compressive stress zone is formed in this area adjacent the periphery, whereas as a reaction thereto, a residual plane tensile stress zone is formed in the inner portion of the glass sheet.

Moreover, during the molding and/or transporting operation of the glass plate by using the ring mold, the portion of the glass plate placed in contact with the ring mold is cooled rapidly. Hence, a residual plane stress can occur in this contacting portion and its vicinity of the glass plate.

According to the conventional art known from Patent Document 1 above, the entire faces of the curved glass plate are forcibly and rapidly cooled (rapidly quenched) to obtain the final product, so that this final product is obtained a so-called heat tempered glass plate.

More particularly, in the peripheral edge of the curved glass plate thus obtained, a portion thereof where a residual plane tensile stress is effective as a residual plane compressive stress zone and a further portion located on the inner side of said portion is formed as a residual plane tensile stress zone, whereas an entire central portion located on the inner side of the residual plane tensile stress zone is heat-tempered by the rapid cooling (rapid quenching) with the cooling air.

Therefore, if this curved glass plate is employed in a laminated glass for an automobile, in the event of e.g. a collision accident, if the driver or passenger's head hits the glass plate, significant impact will be applied to the head, due to the significant strength of the glass plate. Moreover, once a crack is formed in the curved glass plate, the crack will be developed into too small fissures in the plate, so that there is the risk of the driver's view being suddenly hindered by the fissures.

In an attempt to cope with the above problem, there have been proposed a manufacturing method and a manufacturing apparatus constructed such that prior to the rapid cooling or quenching of the bent glass plate with cooling air, a cooling plate having a large heat capacity is brought into contact with the above-described central area of the plate in order to reduce the temperature drop rate in this central area, thereby to restrict the heat tempering of this central area (see Patent Document 2: Japanese Patent Application “Kokai” No. 2002-234756).

As described above, the techniques known from Patent Document 1 and Patent Document 2 are techniques of rapidly cooling (rapidly quenching) the curved glass plate on the lower mold. And, the technique of Patent Document 2 is an attempt to cope with the problem associated with heat tempering by rapid cooling. However, neither of these documents address in particular to or suggest any problem relating to the residual plane tensile stress zone described above.

The present invention relates, on the other hand, to a technique for manufacturing a curved glass plate wherein the bent or curved glass plate is cooled on the lower mold by means of natural cooling or near-natural cooling. More particularly, the present inventors have conducted extensive and intensive experiments regarding a residual plane tensile stress zone on a curved glass plate which was manufactured by natural heat discharge from the curved glass plate on the lower mold. As the result of these experiments, the present inventors have discovered a following problem inherent in such natural or near-natural cooling technique.

Namely, as a result of analysis of the residual plane tensile stress distribution of such curved glass plate obtained by natural cooling, it has been found that the natural cooling is advantageous for avoiding excessive tempering of the central area, hence, for obtaining a glass plate for a laminated glass of an automobile, but that the residual plane compressive stress in the peripheral edge of the glass plate as well as the residual plane tensile stress in the inner portion adjacent the peripheral edge resulting therefrom are both larger than necessary.

Therefore, if such curved glass plate is employed on the outdoor side of a laminated glass for an automobile, the glass can be broken if a cast stone or the like collides the above-described residual plane tensile stress zone.

The stress generating mechanism in the peripheral edge portion and the inner portion of the lower face of the glass sheet described above was analyzed in greater details. As a result, it was found that the relatively strong residual plane compressive stress at the peripheral edge is attributable to the fact that this portion is cooled more rapidly than the other portion of the glass plate because of the low temperature of the lower mold, when the glass place after being heated is placed on this lower mold and that in the problematic inner portion, a strong tensile stress occurs there as a reaction force to a relatively strong residual plane compressive stress occurring in the peripheral edge.

In order to solve the above problem, it is conceivable to limit the residual plane compressive stress at the peripheral edge portion by heating the lower mold, thereby to reduce the residual plane tensile stress in the inner portion.

However, if the inner portion of the lower face of the glass plate is heated during the cooling operation, a surface compressive stress layer will not be formed in the surface of this inner portion of the lower face or even when such layer is formed, the formed layer will be extremely thin. For this reason, if a stone or the like collides this portion, the plate can be easily damaged.

The present invention has been conceived, based on the above-described new finding and perfected by solving the various problems. A primary object of the invention is to provide a method and an apparatus for manufacturing a curved glass plate best suited for use as an outdoor side glass plate of a laminated glass for e.g. an automobile.

### SUMMARY OF THE INVENTION

According to the first characterizing feature of the present invention, a method for manufacturing a curved glass plate comprises the steps of:

mounting a single glass plate heated to a deformable temperature in a heating furnace on a lower mold configured for supporting a lower face peripheral edge of the glass plate outside the heating furnace;

pressing a curved upper mold which bulges downwardly against an upper face of the glass plate to form a curvature in the glass plate; and

cooling the curved glass plate as being mounted on the lower mold by natural cooling or near-natural cooling, thereby to obtain the curved glass plate as a final product;

wherein during said step of cooling the glass plate on the lower mold, the lower mold is heated whereas an inner portion of the lower face of the glass plate adjacent the portion of the glass plate placed in contact with the lower mold is forcibly cooled.

With the above-described first characterizing feature of the invention, a single glass plate which has been heated to a deformable temperature in a heating furnace is mounted on a lower mold configured for supporting a lower face peripheral edge of the glass plate outside the heating furnace, Then, a curved upper mold which bulges downwardly is pressed against an upper face of the glass plate to form a curvature in the glass plate and the curved glass plate as being mounted on the lower mold is cooled by natural cooling or near-natural cooling, thereby to obtain the curved glass plate as a final product. Therefore, it is possible to prevent the curved glass plate per se from being tempered excessively. Accordingly, when this curved glass plate is used in an automobile, even if a driver or passenger's head collides the plate in the event of a collision accident, the risk of the head being damaged by broken plate is small, so that safety can be maintained.

And, since the lower mold is heated during the step of cooling the glass plate on the lower mold, excessive cooling of the peripheral edge of the glass plate by the lower mold can be avoided. Hence, the residual plane compressive stress value at the peripheral edge portion can be restricted and the residual plane tensile stress value at the inner portion thereof can be restricted also. Moreover, since the inner portion of the lower face of the glass plate adjacent the portion of the glass plate placed in contact with the lower mold is forcibly cooled, it is possible to prevent the inner portion from being heated more than necessary by the radiation from the heated lower mold.

Hence, a residual surface compressive stress layer is formed also on the surface of the inner portion. Consequently, it is possible to manufacture a curved glass plate optimum for use in a curved laminated glass employed in e.g. a windshield of an automobile, especially as an outside glass plate of such curved laminated glass.

According to the second characterizing feature of the present invention, a method for manufacturing a curved glass plate comprises the steps of:

mounting a single glass plate heated to a deformable temperature in a heating furnace on a lower mold configured for supporting a lower face peripheral edge of the glass plate outside the heating furnace;

pressing a curved upper mold which bulges downwardly against an upper face of the glass plate to form a curvature in the glass plate; and

cooling the curved glass plate as being mounted on the lower mold by natural cooling or near-natural cooling, thereby to obtain the curved glass plate as a final product;

wherein during said step of cooling the glass plate on the lower mold, the lower mold is heated whereas an inner portion of the lower fie of the glass plate adjacent the portion of the glass plate placed in contact with the lower mold is cooled by blowing radiation from the heated lower mold effective to said inner portion.

With the above-described second characterizing feature of the invention, like the fist characterizing feature of the invention described above, the curved glass plate as being mounted on the lower mold is cooled by natural cooling or near-natural cooling, thereby to obtain the curved glass plate as a final product. Therefore, it is possible to prevent the curved glass plate per se from being tempered excessively. And, since the lower mold is heated during the step of cooling the glass plate on the lower mold, the residual plane compressive stress value at the peripheral edge portion can be restricted and the residual plane tensile stress value at the inner portion thereof can be restricted also.

Moreover, since during the cooling operation of the glass plate on the lower mold, the inner portion of the lower face of the glass plate adjacent the portion of the glass plate placed in contact with the lower mold is cooled by blocking radiation from the lower mold effective to said inner portion, it is possible to prevent the inner portion from being heated more than necessary by the radiation from the heated lower mold.

Hence, a residual surface compressive stress layer is formed also on the surface of the inner portion. Consequently, it is possible to manufacture a curved glass plate optimum for use in a curved laminated glass employed in e.g. a front windshield of an automobile, especially as an outside glass plate of such curved laminated glass.

In the invention's method for manufacturing a curved glass plate, said step of heating the lower mold may be effected by a heater disposed in contact with the lower mold.

With the above, as the heater heats the lower mold, excessive cooling of the portion of the glass plate placed in contact with the lower mold can be avoided.

As a result, the residual plane compressive stress value at the peripheral edge portion can be restricted and the residual plane tensile stress value at the inner portion thereof can be restricted also.

In the invention's method for manufacturing a curved glass plate, during the heating of the lower mold, a temperature of the lower mold can be adjusted such that the higher temperature the lower mold is heated to, the smaller radius of the curvature is be obtained in the curved glass plate.

When a glass plate having a large curvature is to be formed, the time period of contact between the glass plate and the lower mold is long, so that the peripheral edge of the glass plate is apt to be cooled. However, by effecting the above-described temperature adjustment of the lower mold such that the higher temperature the lower mold is heated to, the smaller radius of the curvature is be obtained in the curved glass plate, it is possible to prevent excessive cooling of the peripheral edge portion of the glass plate.

As a result, the residual plane compressive stress value at the peripheral edge portion can be restricted and the residual plane tensile stress value at the inner portion thereof can be restricted also.

In the invention's method for manufacturing a curved glass plate, said cooling of the inner portion adjacent said contacting portion of the glass plate can be effected by discharging cooling air from a cooling air pipe disposed along the inner side of the lower mold.

With this feature, by means of the cooling air discharged from the cooling air pipe disposed along the inner side of the lower mold, it is possible to prevent the inner portion from being heated with the radiation from the lower mold.

As a result, a residual surface compressive stress layer is formed on the surface of the inner portion, hence, a curved glass plate having high strength can be manufactured.

In the invention's method for manufacturing a curved glass plate, said cooling of the inner portion adjacent said contacting portion of the glass plate can be effected by using a cooling water communicating pipe disposed along the inner side of the lower mold.

With this feature, by means of the cooling water communicating pipe disposed along the inner side of the lower mold, it is possible to prevent the inner portion from being heated with the radiation from the lower mold.

As a result, residual surface compressive stress layer is formed on the surface of the inner portion, hence, a curved glass plate having high strength can be manufactured.

According to the third characterizing feature of the present invention, an apparatus for manufacturing a curved glass plate comprises:

a lower mold configured for supporting, outside a heating furnace, a lower face peripheral edge of a single glass plate which has been heated to a deformable temperature in the heating furnace;

a curved upper mold which bulges downwardly and is disposed upward of the lower mold;

said lower mold and said upper mold being vertically movable closer to and away from each other;

heating means for heating said lower mold; and

cooling means for forcibly cooling an inner portion of a lower face of the glass plate adjacent the portion of the glass plate placed in contact with the lower mold.

With the above-described third characterizing feature of the invention, the apparatus comprises a lower mold configured for supporting, outside a heating furnace, a lower face peripheral edge of a singe glass plate which has been heated to a deformable temperature in the heating furnace, a curved upper mold which bulges downwardly and is disposed upward of the lower mold, heating means for heating said lower mold, and

cooling means for forcibly cooling an inner portion of a lower face of the glass plate adjacent the portion of the glass plate placed in contact with the lower mold. Hence, by implementing the method having the first characterizing feature with the above apparatus, it is possible to manufacture a curved glass plate ideally suited for use as an outdoor side glass plate of a laminated glass for e.g. an automobile.

According to the fourth characterizing feature of the present invention, an apparatus for manufacturing a curved glass plate comprises:

a lower mold configured for supporting, outside a heating furnace, a lower face peripheral edge of a single glass plate which has been heated to a deformable temperature in the heating furnace;

a curved upper mold which bulges downwardly and is disposed upward of the lower mold;

said lower mold and said upper mold being vertically movable closer to and away from each other;

heating means for heating said lower mold; and

heat blocking means for blocking application of radiation from the heated lower mold to an inner portion of the lower face of the glass plate adjacent the portion of the glass plate placed in contact with the lower mold.

With the fourth characterizing feature, the apparatus comprises a lower mold configured for supporting, outside a heating furnace, a lower face peripheral edge of a single glass plate which has been heated to a deformable temperature in the heating furnace, a curved upper mold which bulges downwardly and is disposed upward of the lower mold, heating means for heating said lower mold, and heat blocking means for blocking application of radiation from the heated lower mold to an inner portion of the lower face of the glass plate adjacent the portion of the glass plate placed in contact with the lower mold. Hence, by implementing the method having the second characterizing feature with the above apparatus, it is possible to manufacture a curved glass plate ideally suited for use as an outdoor side glass plate of a laminated glass for e.g. an automobile.

In the invention's curved glass plate manufacturing apparatus, said heating means can include a heater disposed in contact with the lower mold.

With the above, as the heater heats the lower mold, excessive cooling of the portion of the glass plate placed in contact with the lower mold can be avoided.

As a result the residual plane compressive stress value at the peripheral edge portion can be restricted and the residual plane tensile stress value at the inner portion thereof can be restricted also.

In the invention's apparatus for manufacturing a curved glass plate, said heating means can include a temperature adjusting mechanism.

When a glass plate having a large curvature is to be formed, the time period of contact between the glass plate and the lower mold is long, so that the peripheral edge of the glass plate is apt to be cooled. However, as the heating means includes a temperature adjusting means, it is possible to adjust the temperature of the lower mold depending on a desired curvature to be obtained in the curved glass plate. Hence, it is possible to prevent excessive cooling of the peripheral edge portion of the glass plate.

As a result, the residual plane compressive stress value at the peripheral edge portion can be restricted and the residual plane tensile stress value at the inner portion thereof can be restricted also.

In the invention's apparatus for manufacturing a curved glass plate, said cooling means can include a cooling air pipe disposed along the inner side of the lower mold and capable of discharging cooling air.

With this feature, by means of the cooling air discharged from the cooling air pipe disposed along the inner side of the lower mold, it is possible to prevent the inner portion from being heated with the radiation from the heated lower mold. As a result, a compression layer is formed on the surface of the inner portion, hence, a curved glass plate having high strength can be manufactured.

In the invention's apparatus for manufacturing a curved glass plate, said cooling of the inner portion adjacent said contacting portion of the glass plate can be effected by using a cooling water communicating pipe disposed along the inner side of the lower mold.

With this feature, by means of the cooling water communicating pipe disposed along the inner side of the lower mold, it is possible to prevent the inner portion from being heated with the radiation from the heated lower mold.

As a result, a compression layer is formed on the surface of the inner portion, hence, a curved glass plate having high strength can be manufactured.

Further and other features and advantages of the invention will become apparent upon reading the following detailed disclosure of preferred embodiments thereof with reference to the accompanying drawings.

### BRIEF DESCRIPTION OF THE DRAWINGS

FIG. 1 is a schematic construction view of an apparatus for manufacturing the curved glass plate relating to one preferred embodiment of the present invention,

FIG. 2 is a perspective view showing principal portions of the curved glass plate manufacturing apparatus,

FIG. 3 is a section view showing principal portions of the manufacturing apparatus,

FIG. 4 is another section view showing the principal portions of the apparatus,

FIG. 5 is a section view showing principal portions of a curved glass plate manufacturing apparatus relating to a further embodiment of the present invention, and

FIG. 6 is a section view showing principal portions of a curved glass plate manufacturing apparatus relating to a still further embodiment of the present invention.

### DESCRIPTION OF PREFERRED EMBODIMENTS

Preferred embodiments of a method and an apparatus for manufacturing a curved glass plate will be now described in details with reference to the accompany drawings.

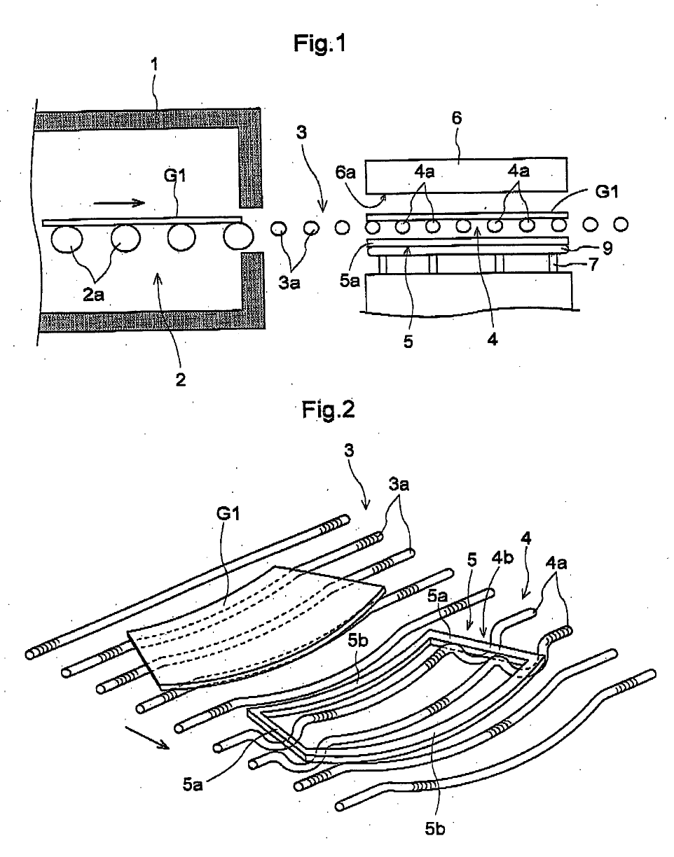

The curved glass plate relating to the present invention is particularly suitable for use as an outdoor side glass plate of a laminated glass employed in an automobile. FIGS. 1 and 2 show an apparatus employed for manufacturing such curved glass plate G described above. This apparatus includes a heating furnace 1 for heating a flat glass plate (bank) G1 and inside the heating furnace 1, there is arranged a roller type inner-furnace conveyer 2 comprising many straight rollers 2a.

On the conveying-wise downstream of the inner-furnace conveyer 2 and outside the heating furnace 1, there is arranged a first conveyer 3 which is constructed also as a roller type conveyer comprising a plurality of curved rollers 3a. Further, on the downstream of the first conveyer 3 and outside the heating furnace 1, there is arranged a second conveyer 4 which is constructed also as a roller type conveyer comprising a plurality of curved rollers 4a.

The first conveyer 3 and the second conveyer 4 are provided for progressively bending the heated glass plate G1 in advance. At a portion of the second conveyer 4, there are disposed a lower mold 5 (known as a ring mold) arranged downwardly of the second conveyer 4 and an upper mold 6 disposed upwardly of the conveyer 4.

The lower mold 5 is adapted for supporting a lower face peripheral edge of the glass plate G1. For this purpose, the lower mold 5 is provided as a rectangular frame-like assembly consisting of a pair of vertical frame members 5a corresponding to the opposed lateral sides of the glass plate and a pair of lateral frame members 5b corresponding to the upper and lower sides of the glass plate. Further, this lower mold 5 is adapted to be movable up/down by means of an unillustrated cylinder or the like via a plurality of struts 7 extending downwardly.

When the lower mold 5 is moved to its lowermost position, the pair of vertical frame members 5a are received within opposed concave portions 4b of the curved rollers 4a and also the pair of lateral frame members 5d are located downwardly of a conveying plane of the second conveyer 4, thereby to avoid interference with the respective curved rollers 4a or the glass plate G1.

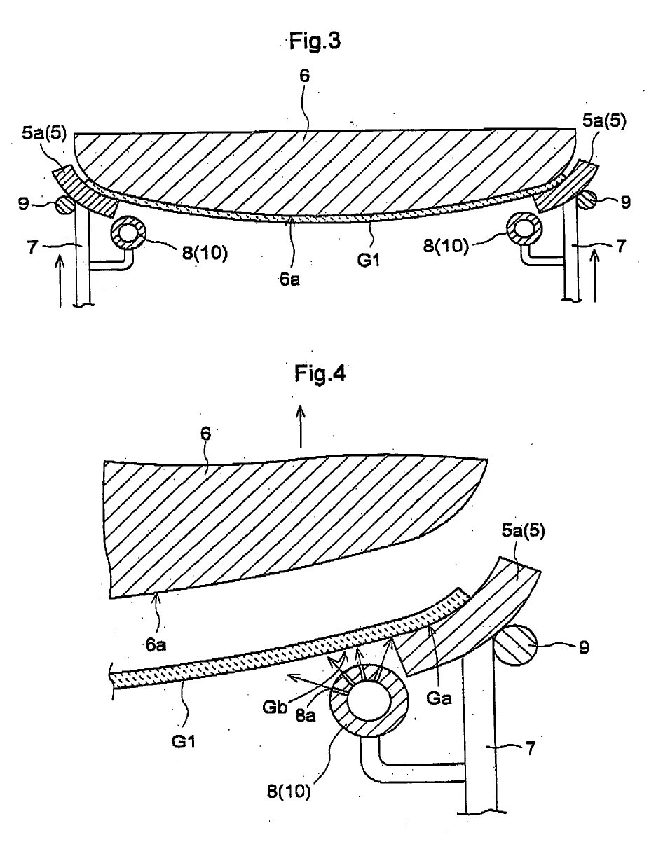

As shown in FIGS. 3 and 4, the lower mold 5 incorporates a cooling air pipe 8 arranged along the inner sides of the vertical frame member 5a and the lateral frame member 5b and a heater 9 arranged in contact with bottom faces of the vertical fame member 5a and the lateral fame member 5b. The cooling air pipe 8 and the heater 9 are adapted to be movable up/down together with the lower mold 5, The cooling air pipe 8 defines a number of air discharging holes 8a.

The cooling air pipe 8 constitutes a cooling means 10 and the heater 9 constitutes a heating means, respectively. The heater 9 includes a temperature adjusting mechanism for adjusting a heating temperature of the heater when heating the lower mold 5. The pipe 8 and the heater 9 will be described in details later herein.

On the other hand, the upper mold 6 includes a curvature-forming curved surface portion 6a which bulges downwardly. In operation, by lifting up/down the lower mold 5 and also the upper mold 6 if necessary, the lower mold 5 can be moved closer to or away from the upper mold 6.

Next, a series of operations of this curved glass plate manufacturing apparatus and a method for manufacturing the plate using the apparatus will be described.

First, in association with rotational drive of the straight rollers 2a thereof, the inner-furnace conveyer 2 conveys the flat glass plate G1 inside the heating furnace 1 in a direction indicated by the arrow. During this conveying operation, the heating furnace 1 heats the glass plate G1 to a predetermined temperature, i.e. a temperature at which the plate can be deformed. Then, the plate G1 is discharged from the furnace 1.

The glass plate G1 existing the furnace is then conveyed by the first conveyer 3 and then by the second conveyer 4. During a series of these conveying operations, the glass plate G1 is progressively bent by the cured rollers 3a, 4a of the respective conveyers 3, 4 which are being rotatably driven.

When the glass plate G1 reaches a predetermined position on the second conveyer 4, the conveying operation of the glass plate G1 by the second conveyer 4 is stopped. Then, the lower mold 5 is lifted up, so that the peripheral edges of the four sides of the rectangular bottom face of the plate G1 are supported on and lifted up by the pair of vertical frame members 5a and the pair of the lateral frame members 5b.

In association with the above-described liming operation, the top face of the glass plate G1 is pressed against the upper mold 6 with a predetermined pressing force. Then, while the glass plate G1 is clamped between the lower mold 5 and the upper mold 6 and also the plate G1 is forcibly drawn and sucked against the curved surface 6a of the upper mold 6 by means of an unillustrated sucking means incorporated in this upper mold 6, the glass plate G1 is bent by the curved surface 6a.

During the above-described molding operation, the lower mold 5 is heated by the heater 9 incorporated therein, so that excessive cooling of the four side peripheral edges of the glass plate G1 by the lower mold 5 is avoided. When a glass plate G1 having a large curvature (deeply curved glass plate) is to be formed, the time period of contact between the glass plate G1 and the lower mold 5 is long, so that the glass plate G1 is apt to be cooled through the contact. In such case, it is necessary to heat the lower mold 5 to a temperature higher than usual. Therefore, by means of the temperature adjusting mechanism included in the heater 6, the temperature of the lower mold 5 is adjusted, depending on the magnitude of curvature of the curved glass plate.

Thereafter, the lower mold 5 is lowered to a predetermined position and/or the upper mold 6 is raised to a predetermined position. Then, the curved glass plate G1 as being left mounted on the lower mold 5 is cooled by natural or near-natural cooling (by applying additional cooling air during the natural cooling).

During this cooling operation of the glass plate G1, cooling air is discharged from the cooling air discharging holes 8a of the cooling air pipe 8, so as to forcibly cool the inner portion Gb described above. Therefor, the effect of radiation from the lower mold 5 can be restricted.

Thereafter, the curved glass plate manufactured in the manner described above can be affixed with a separately manufactured indoor side glass plate to form a laminated glass (assembly),

### Other Embodiments

Next, other embodiments will be described. In the following discussion of further embodiments, in order to avoid redundancy of explanation, the same components or components having same or similar functions as those employed in the foregoing embodiment will only be denoted with same reference marks, without further explanation thereof in repetition. Hence, the following discussion will focus on differences from the foregoing embodiment.

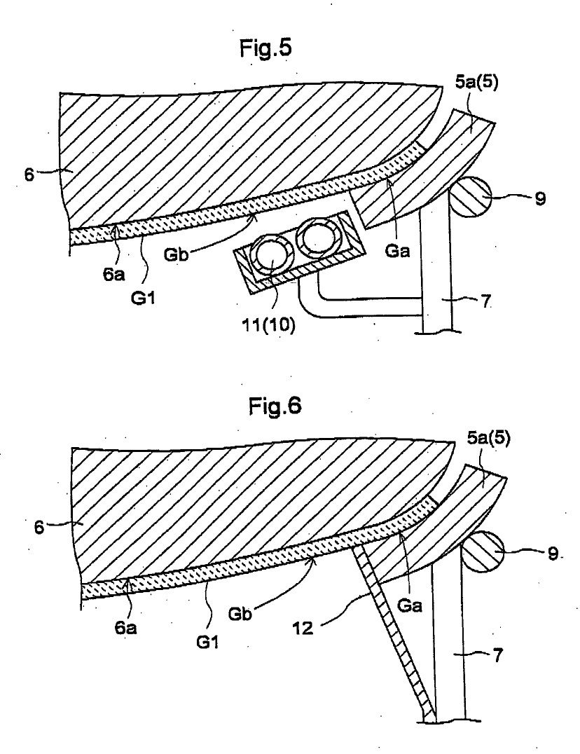

In the foregoing embodiment, the cooling unit having the cooling air pipe 8 was described as an example of the cooling means 10. Instead of this cooling air pipe 8, as shown in FIG. 5 for example, the cooling means 10 can comprise a cooling water communicating pipe 11 may be disposed along the inner sides of the vertical frame members 5a and the lateral frame members 5b,

Further, as shown in FIG. 6, a heat blocking member 12 can be disposed along the inner sides of the vertical frame members 5a and the lateral frame members 5b in order to restrict the effect of radiation from the lower mold 5.

Further, the cooling means 10 comprising the cooling air pipe 8 or the cooling water communicating cooling pipe 11 can be used in combination with the heat blocking member 12 in order to restrict the effect of radiation from the lower mold 5.

Moreover, the heater 9 was employed in the foregoing embodiment as an example of the heat means for heating the lower mold 5. Instead of this heater 9, the heating means can comprise also a hot air discharging pipe or a hot fluid communicating pipe.

1. A method for manufacturing a curved glass plate comprising:
mounting a single glass plate which has been heated to a deformable temperature in aheating furnace on a lowe rmold configured for supporting a lower face perihpheral edge of the glass plate outside the heating furnace;
pressing a curved upper mold which bulges downwardly against an upper face of the glass plate to form a curvature in the glass plate to form a curved glass plate; and
cooling the curved glass plate on the lower mold by natural cooling or near-natural cooling;
wherein during said step of cooling the glass plate on the lower mold, the lower mold is heated, whereas an inner portion of the lower face of the glass plate adjacent the portion of the glass plate placed in contact with the lower mold is forcibly cooled.

2. A method for manufacturing a curved glass plate comprising:
mounting a single glass plate which has been heated to a deformable temeprature ina heating furnace on a lower mold configured for supporting a lower face peripheral edge of the glass plate outside the heating furnace;
pressing a curved upper mold which bulges downwardly against an upper face of the glass plate to form a curvature in the glass plate to form a curved glass plate; and
cooling the curved glass plate on the lower mold by natural cooling or near-natural cooling;
wherein during said step of cooling the glass plate on the lower mold, the lower mold is heated, whereas an inner portion of the lower face of the glass plate adjacent the portion of the glass plate placed in contact with the lower mold is cooled by blocking radiation from the heated lower mold effective to said inner portion.

3. The method according to claim 1, wherein said step of heating the lower mold is effected by a heater disposed in contact with the lower mold.

4. The metohd according to claim 1, wherein during the heating of the lower mold, a temperature of the lower mold is adjusted such that as the temperature the lower mold is heated to increases, the radius of the curvature is to be obtained in the curved glass plate decreases.

5. The method according to claim 1, wherein said cooling of the inner portion adjacent said contacting portion of the glass palte is effected by discharging cooling air from a cooling air pipe disposed along the inner side of the lower mold.

6. The method according to claim 1, wherein said cooling of the inner portion adjacent said cotnacting portion of the glass plate is effected by using a cooling water communicating pipe disposed along the inner side of the lower mold.

7. An apparatus for manufacturing a curved glass plate comprising:
a lower mold configured for supportin, outside a heating furnace, a lower face peripheral edge of a single glass plate which has been heated to a deformable temperature in the heating furnace;
a curved upper mold which bulges downwardly and is disposed upward of the lower mold;
said lower mold and said upper mold being veritically movable relating to ach other;
heating means for heating said lower mold; and
cooling means for forcibly cooling an inner portion of a lower face of the glass plate adjacent the portion of the glass plate placed in contact with the lower mold.

8. An apparatus for manufacting a curved glass plate comprising:
a lower mold configured for supporting, outsdie a heating furnace a lower face peripheral edge of a single glass plate which has been heated to a deformable temperature in the heating furnace;
a curved upper mold which bulges downwardly and is disposed upward fo the lower mold;
said lower mold and said upper mold being vertically movable closer to and away from each other;
heating means for heating said lower mold; and
heat blocking means for blocking application of radiation from the lower mold to an inner portion of the lower face of the glass plate adjacent the portion of the glass plate placed in contact with the lower mold.

9. The appartus according to claim 7, wherein said heatin gmeans includes a heater disposed in cotact with the lower mold.

10. The apparatus of claim 7, whrein said heating means includes a temperature adjusting mechanism.

11. The apparatus according to claim 7, wherein said cooling means includes a cooling air pipe disposed along the inner side of the lower mold and capable of discharging cooling air.

12. The apparatus according to claim 7, wherein said cooling means includes a coolingn water communicating pipe disposed along the inner side of the lower mold.

13. The method according to claim 2, wherein said step of heating the lower mold is effected by a heater disposed in contact with the lower mold.

14. The metohd according to claim 2, wherein during the heating of the lower mold, a temperature of the lower mold is adjusted such that as the temperature the lower mold is heated to increases, the radius of the curvature is to be obtained in the curved glass plate decreases.

15. The appartus according to claim 8, wherein said heatin gmeans includes a heater disposed in cotact with the lower mold.

16. The apparatus of claim 8, whrein said heating means includes a temperature adjusting mechanism.
